(19) United States
(12) Patent Application Publication
(10) Pub. No.: US 2020/0097249 A1
(43) Pub. Date: Mar. 26, 2020

(54) COMPUTER APPARATUS FOR PLAYBACK OF AUDIO

(71) Applicant: Travis Jessop, Heber, UT (US)

(72) Inventor: Travis Jessop, Heber, UT (US)

(21) Appl. No.: 16/578,267

(22) Filed: Sep. 20, 2019

Related U.S. Application Data
(60) Provisional application No. 62/733,652, filed on Sep. 20, 2018.

(51) Int. Cl. G06F 3/16; G05B 15/02

(52) U.S. Cl. CPC G06F 3/165; G05B 15/02

(57) ABSTRACT

An apparatus for recording and playing back a recording comprising a recording module, a storage module, a playback module, a playlist module, and a mix module. The recording module records a recording which is then stored in the storage module, then played back using the playback module, with a plurality of recordings being able to be stored in the playlist module. While the playback module operates, the mix module enables a separate playback module to operate. Simultaneous playback of modules enables the creation of subliminal message audio.

### TECHNICAL FIELD

The disclosure relates generally to computer apparatuss for playing user recorded messages. Specifically, the disclosure relates to an apparatus for playing user recorded messages simultaneously with other audio sources and a subliminal message or messaging.

### BACKGROUND

Affirmations and memos-to-self have been a frequent use of recording apparatuss since their inception, however the use of such recordings to enable subliminal reflection and meditation has normally required multiple apparatuss or premixed and produced audio tracks. Existent methods of audio playback on computer apparatus will not replay the recordings at a separate volume in conjunction with all other applications.

A need exists for commercially available applications enabling the user to access and play their personal voice recording content at the same time or in addition to other running apps. In addition, a need exists for an application enabling the user to control the voice recording volume output separately from all other running applications. A user could play music on an external stereo and play voice recordings from a mobile apparatus at the same time, however this would require controlling the volume output separately on the external stereo and the mobile apparatus. In addition, the volume output would be generated from two separate locations; music from the stereo and a voice recording from the mobile apparatus.

### BRIEF SUMMARY

The use of subliminal messages while engaging with other forms of media may be a powerful tool for self-help, positive thinking, and the development of habits in one's life. The ability to generate one's own subliminal messages in conjunction with recording and playback of self-affirming statements better enables these positive activities while also customizing them to a user's own needs.

Examples extend to apparatus, apparatuss, methods, systems, and computer program products for controlling apparatuss and aggregating media content, such as two or more threads of audio files or an audio file thread aggregated with a movie file. The present invention generally relates to systems and methods for aggregating access to and delivery of media content over a network. A computer apparatus for the recording, storage, playback, or mixing with additional playback sources is described. The computer apparatus may include a recording module, a storage module, a playback module, a playlist module, and a mix module. The recording module may be connected to the storage module in such a way that a user is able to record audio such as mantras, affirmations, self-help statements, and the like, and is able to store these recordings. The storage module may be connected to the playback module and the playlist module such that the user may be able to select a single recording or a plurality of recordings to add to a playlist so that the audio recordings may be played back in the user's preferred order via the playlist module. The playback module may also include a volume control module, which may operate independently of any other audio control modules the computer apparatus may have. The playback module may also be connected to the mix module, which may allow the computer apparatus to instruct the apparatus to continually playback a recording and may allow the computer apparatus to then utilize other audio sources contained within the computer apparatus. This mix module may further enable the playback module to utilize the volume control module independently of any separate audio sources. Use of the mix module may enable a user to create subliminal messages via the simultaneous playback of separate audio sources.

### BRIEF DESCRIPTION OF THE DRAWINGS

A more particular description of the invention briefly described above is made below by reference to specific example. Several examples are depicted in drawings included with this application. An example is presented to illustrate, but not restrict, the invention.

FIG. 1 illustrates a computer apparatus for recording, storage, and playback of recorded audio;

FIG. 2 illustrates a method for presenting an augmented reality image;

FIG. 3 illustrates a flow chart of the steps to record, store, create a playlist, playback, and mix a recording, thus activating an overlay module (200) for interacting with the computer apparatus while utilizing a separate playback module;

FIG. 4 illustrates an embodiment of the computer apparatus and the varied screens thereof, including creating an audio recording and playing back an audio recording;

FIG. 5 illustrates a basic sign up workflow of an embodiment of the computer apparatus;

FIG. 6 illustrates a basic password workflow of an embodiment of the computer apparatus;

FIG. 7 illustrates a basic user dashboard workflow of an embodiment of the computer apparatus;

FIG. 8 illustrates a basic sign up workflow of an embodiment of the computer apparatus;

FIG. 9 illustrates a basic recording storage/access workflow of an embodiment of the computer apparatus;

FIG. 10 illustrates an apparatus for creating audio with a subliminal message.

FIG. 11 illustrates a method for creating audio with a subliminal message.

FIG. 12 illustrates apparatus for creating audio with a subliminal message.

FIG. 13 illustrates a method for creating audio with a subliminal message.

FIG. 14 illustrates a computer program product for creating audio with a subliminal message.

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations, without departing from the substance of the claimed invention. Thus, the detailed description of the examples in the figures is merely representative of an example of the invention, and is not intended to limit the scope of the invention as claimed. Computer program products and methods are included within the scope of the invention.

For purposes of this disclosure, a module refers to a combination of hardware and program instructions to perform a designated function. Each module may include a processor and memory. The modules may collectively share a processor and memory. The program instructions may be stored in the memory and may cause the processor to execute the designated function of the number of modules. Additionally, a smartphone application and a corresponding computer system may be used to implement a module or a combination of modules.

A purpose of the claimed computer apparatus will be to enable a user to use a computer apparatus for audio playback via two playback modules where all audio output controls are accessible on the same computer apparatus. One such embodiment allows music content or audio content generated from all other mobile applications to be available to for use in unison with personal voice recordings at the same time, or on the same computer apparatus. Such an embodiment may add a benefit in that all related tasks and controls are all accessible on the user's computer apparatus.

For purposes of this disclosure as used in the present specification and in the appended claims the term “recording,” as used herein, refers to an electronic audio recording of a mantra, affirmation, voice message, self-help statement, or similar electronic audio recording. Such recordings may be played back independently, or played concurrently with other audio sources to create a subliminal message.

As used in the present specification and in the appended claims, the term “playback module” refers to the playback module used to play the recordings generated by the recording module. The term “separate playback module” refers to any other source of audio, including video, which may include commercially available applications such as “iTunes”, “Pandora”, “YouTube”, “Netflix”, or the like. The distinction being that other audio sources which may be played back are not part of the main playback module and comprise a separate, discrete audio source.

As used in the present specification and in the appended claims, the term “playback” refers to the use of a playback module to play a recording. In one embodiment the mix module is configured as a mix button or slide button. In such an embodiment, if the mix button is not turned on, the playback of affirmations will cease when the application is navigated away from to another app.

As described above, vocal recordings such as affirmations, mantras, and self-help statements may be listened to directly, or combined with a second source of audio to become subliminal messages. Subliminal messages allow a user to enjoy a chosen audio or video source while subconsciously hearing the chosen vocal recording and thus benefiting from the repeated listening and mild brainwashing effect subliminal messages may provide. Often subliminal messages are used for advertising or otherwise negatively perceived uses, and the tools to create one's own message tailored to one's own motivational needs are lacking.

By integrating the ability to create one's own vocal recordings with a simultaneous playback system, a user may be able to benefit from the positive aspects of subliminal message use, and may be able to tailor the experience to their own needs to maximize the benefit of such messages. Tailoring a subliminal message in this manner may be done by, for example, choosing the concurrent audio from a number of the user's preferred audio sources, including video sources, and controlling the sound level of the recording, i.e. the subliminal message, and a secondary audio source.

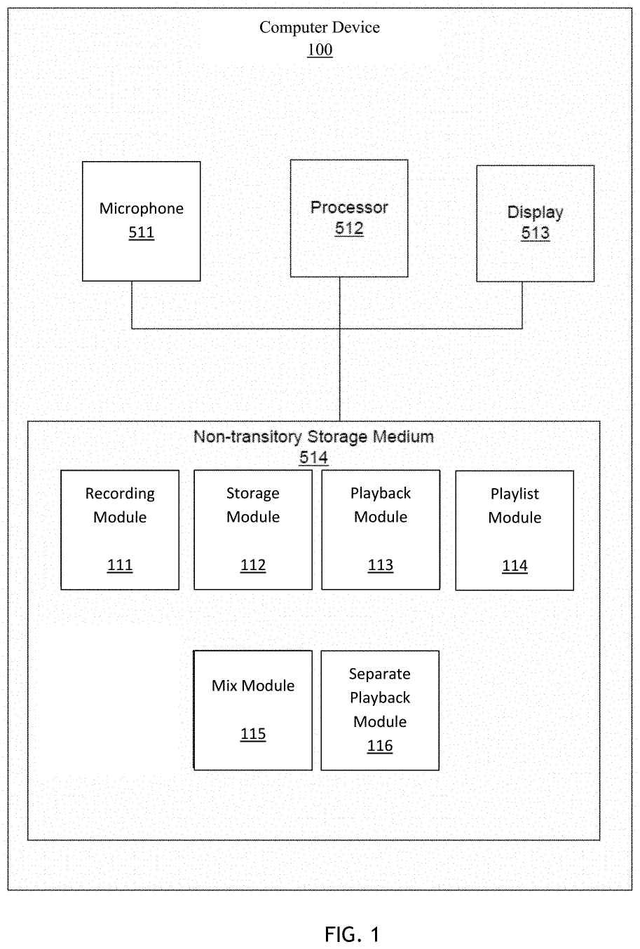

Referring now to the figures, one embodiment of the invention as illustrated in FIG. 1 describes the computer apparatus (110) as comprising a set of hardware elements such a microphone (511), a processor (512), and a display (513). These elements are utilized in conjunction with the non-transitory storage medium (514) to operate the modules of the computer apparatus.

The recording module (111) may interact with the microphone (511) to record an electronic vocal recording which is then stored in the storage module (112). This recording may be edited and added to the playlist module (114), and may be used with the playback module (113) to play the recording in a repeated loop, which a user may listen to while engaging in other daily tasks. Further, the mix module (115) may be utilized to allow the playback of a separate playback module (116), enhancing the subliminal message aspects of the recording.

The mix module 116 of the computer apparatus may be embodied as a mix button, as shown in FIG. 11.

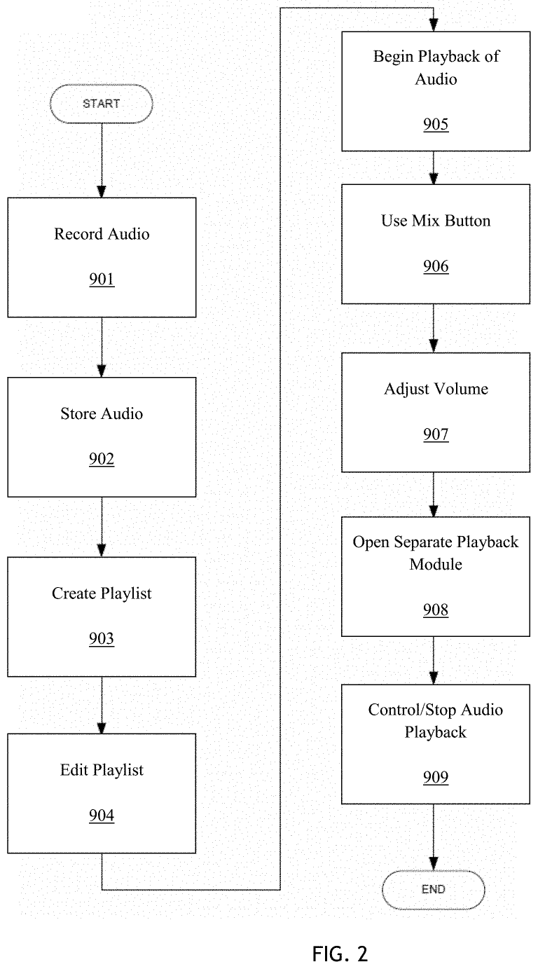

Although steps of a process or a method may be listed in a certain order, any combination or ordering of the steps is contemplated. The entire process from creating a recording to playing it back with a separate audio source is detailed in FIG. 2. This process may entail using the recording module (111) to record the audio in Step 901, then storing the audio in the storage module (112) in Step 902. Next, the playlist module (114) may be activated in Step 903 and used to create a playlist in Step 903, which may be further edited in Step 904. Next, the playback module (113) may be activated to begin playback in Step 905. The mix module (115) may be activated via the mix button (200), in step 906, and then the volume of the recorded is audio determined in Step 907. A separate playback module (116) may then be activated in Step 908. Control of the playback of both audio sources is then enabled via the playback module (113) and separate playback module (116).

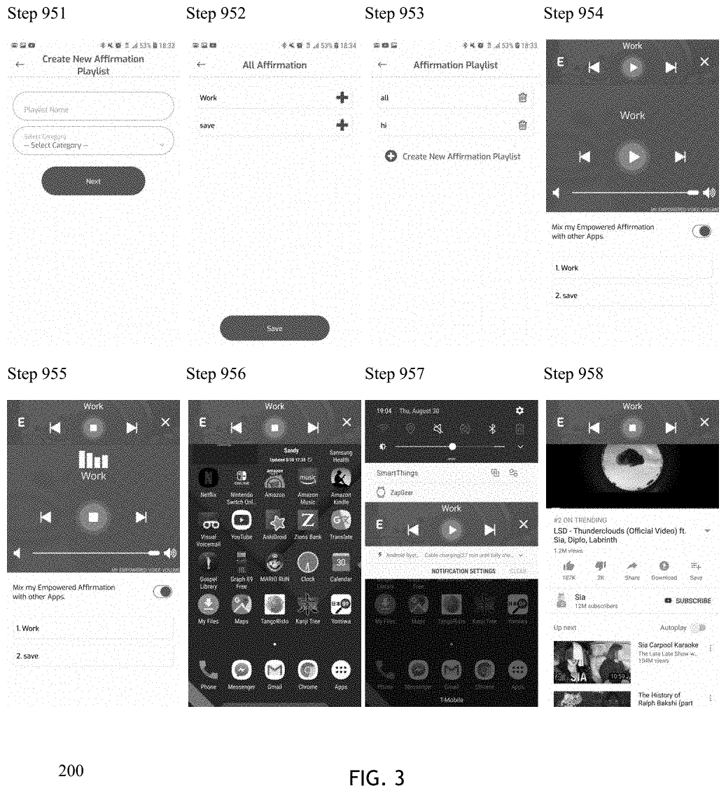

The use of the mix module (115) may be embodied to engage an overlay module (200), which may overlay all other screens of the apparatus as shown in steps 955 through 958 of FIG. 3. Usage of this will may allow control of the playback module (113) while the screen of the computer apparatus (100) displays the separate playback module (116).

FIG. 3 illustrates the steps that may be taken to engage the overlay module (200), starting with the creation of a playlist using the playlist module (114) in Step 951. Step 952 and Step 953 show a process for adding recordings to a playlist, before proceeding to the playback module (113) in Step 954. The playback module (113) may be used to begin playback and with the mix module (115), here embodied as a button, activated, the playback module (113) may be closed, and the various screens and additional applications or software items on the computational apparatus may be accessed as shown in Steps 956 and 957. While the mix module (115) is active, the playback of the recordings in the playlist may be continued and a separate playback module (116) may be activated. Step 958 shows an exemplary, separate playback module (116), here YouTube®, being used to playback audio and video while the overlay (200) may allow control of the playback module (113) and the recording.

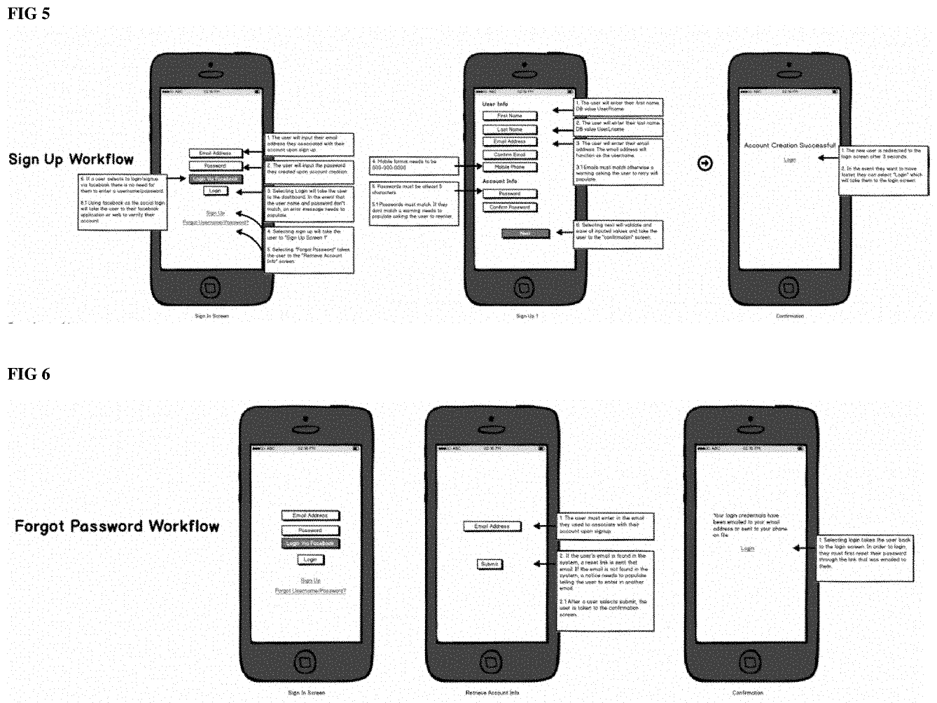

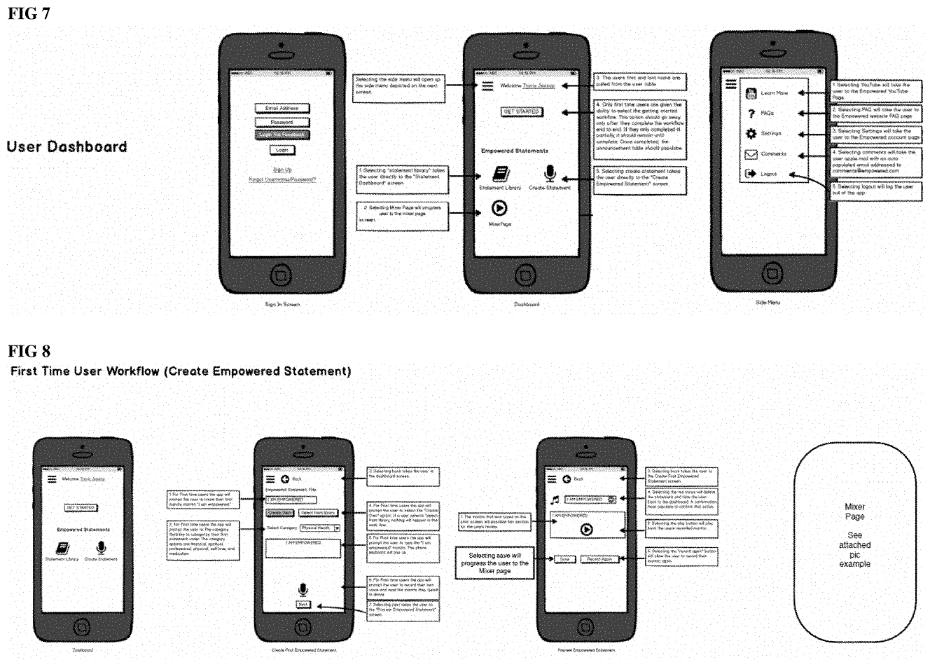

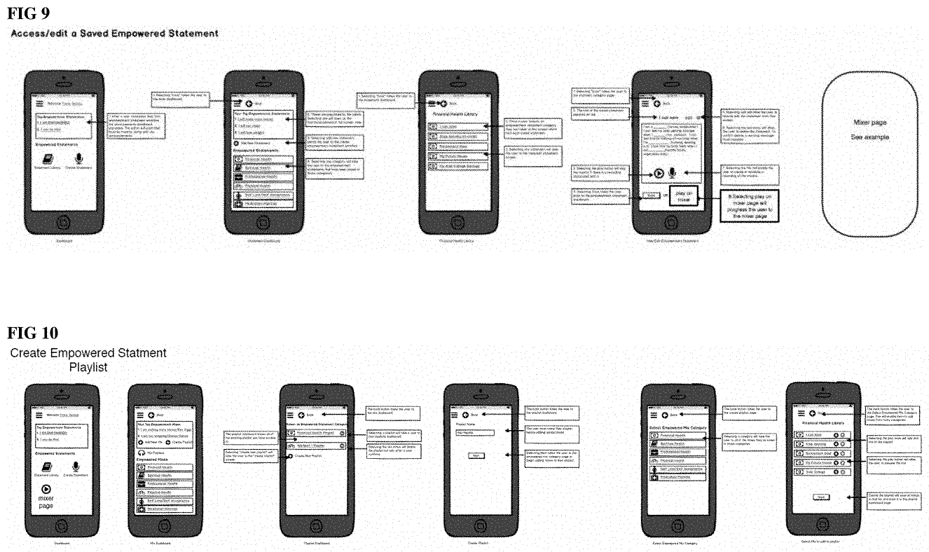

Embodiments of the process of creating a user account, as well as basic password functionality, application utilization, recording of an audio recording and subsequent playback are illustrated in FIG. 5 through FIG. 11. This process may allow a user to:
a. Create a voice recording,
b. Store and categorize a voice recording in an Affirmation library. Examples of categories that may be used for categorizing including: fitness, health and wealth, emotional support, self-development, and goals
c. Create a playlist and play selected playlists from an Affirmation mixer.
d. If a user chooses to play voice recordings in addition to other running applications the user must turn on the “Mix my affirmations with other Apps” toggle.
e. Adjust the voice recording volume output to desired level from the Affirmation mixer page.

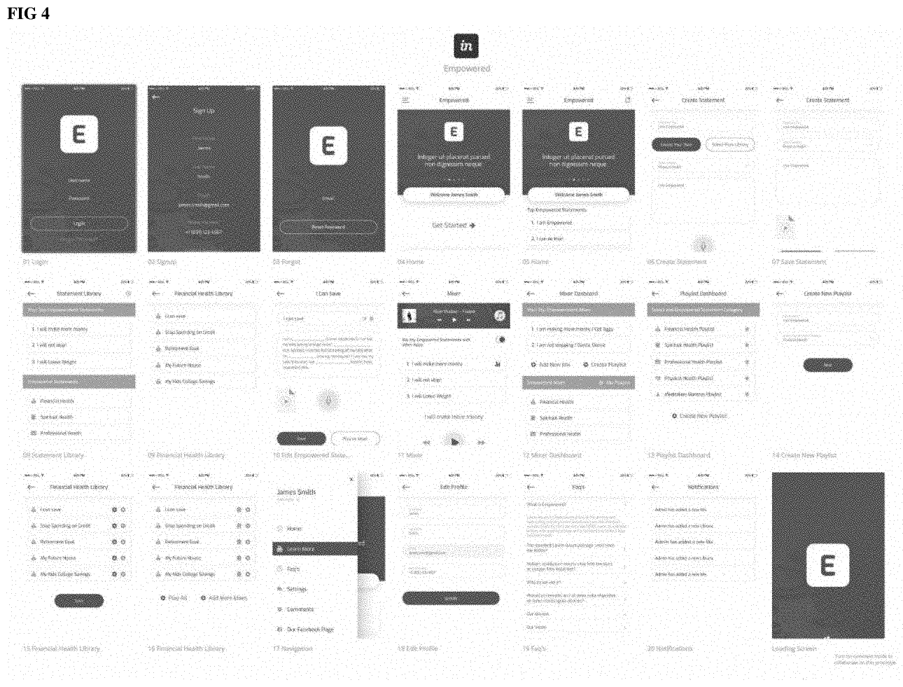

In FIG. 4 the steps involved in creating and using a recording are organized in a screen-based flowchart. The initial step may be to record an audio clip, then to store the audio clip; at this point the recording man be played back as-is, or may be added to a playlist before playing it back. Once playback of the recording has started the mix module (115) may be activated to utilize a separate playback module (116) of the computer apparatus to allow the recording to be used as a subliminal message while the separate audio source is played back. The screen images here illustrate one potential embodiment and user experience.

The audio generated by the playback module (113) may be configured such that the amplitude of the volume is between 5% and 75% of the amplitude of the volume of the separate playback module (116), and may maintain this ratio, which may be between 0.05 to 0.9, as the volume of the separate playback module (116) is adjusted. The audio generated by the playback module (113) may be configured such that the amplitude of the volume is between 2% and 95% of the amplitude of the volume of the separate playback module (116), and may maintain this ratio, which may be between 0.05 to 0.9, as the volume of the separate playback module (116) is adjusted.

In some embodiments the playback module (113) may include binaural beat options for combination with the recordings.

In some embodiments the playlist module (114) may include the option to add community groups to allow users to interact with each other by sharing personal voice recordings and ideas across playlists.

In some embodiments the playback module (113) may include a volume toggle which works within the computing apparatus and may control the volume level of the recording. The playback module (113) may work independently from any mobile apparatus volume controls in which the computer apparatus may be embodied, and which should instead control the separate playback module (116).

One possible embodiment of the computer apparatus may include the use of threads of execution to act as the separate playback modules. Threads of execution are discrete system components of the computer apparatus which may embody a task running on such an apparatus, and many threads may be ran concurrently. In a thread-based embodiment the playback module (113) thread may begin operation when the user engages the computer apparatus, and the mix module (115) and associated mix button may enable the playback module (113) thread to continue playback while the separate playback module (116) thread is started and additional audio is played on the computer apparatus. When the payback module (113) is closed, the overlay (200) may appear on screen while the playback module (113) thread continues operation while additional threads begin operation independently. In such a scenario, the overlay (200) may control the thread of the playback module (113) and the physical audio buttons of the computer apparatus may control the volume level of the apparatus and all threads running thereon. In this way, multiple threads combine to mix the audio which the computer apparatus will play back simultaneously.

In the previously-disclosed embodiment, the use of threads to control each audio source may be useful in generating subliminal messages via the recordings being played back in one thread, and separate audio sources being played back in other threads, as the recording may be played back at a user chosen volume level. In some embodiments, a module may display on a computer screen a sample affirmation statement. The module may receive user input and select an affirmation statement based on a user selection, such as selecting and then presenting an affirmation related to daily exercise. The module may present categories of affirmation to a user and then receive a selection for one or more of the categories and then display one or more affirmations related to the selected category.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

In some embodiments, a user may record a message at a certain volume range, such as between 55 dB and 65 db. When converting the message into a subliminal message, various methods may be used when there is a fluctuation in the volume of the recorded message: converting the entire message to a dB volume that is a certain percentage of the highest dB level of the original message; maintaining the relative fluctuation of the original message by maintaining the ratio between the highest dB level of the original and the lowest dB level of the original; determining an average dB level of the original message and converting the volume of the average dB level into a sub-audible level; converting the message so that it has a certain sub-audible volume that does not fluctuate in volume like the original.

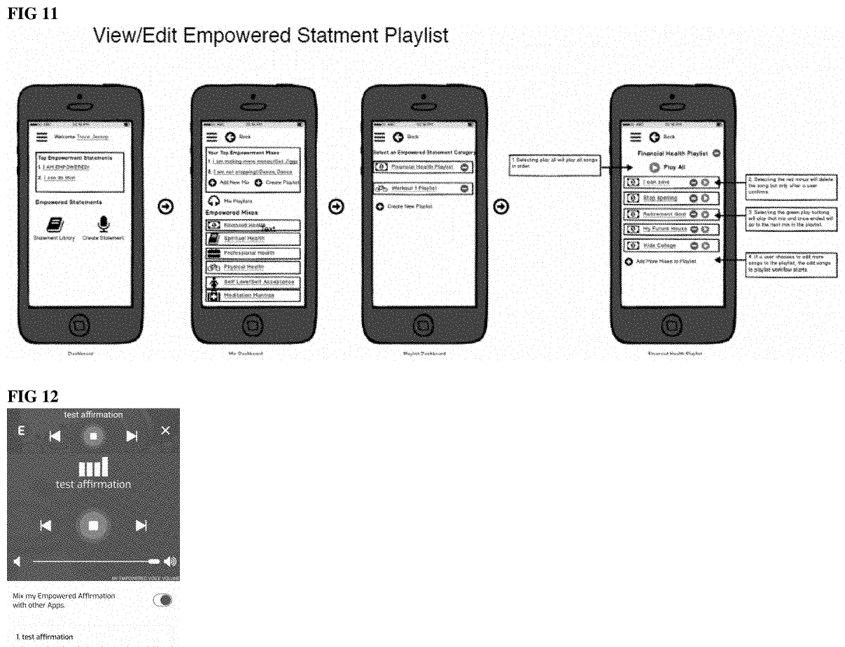

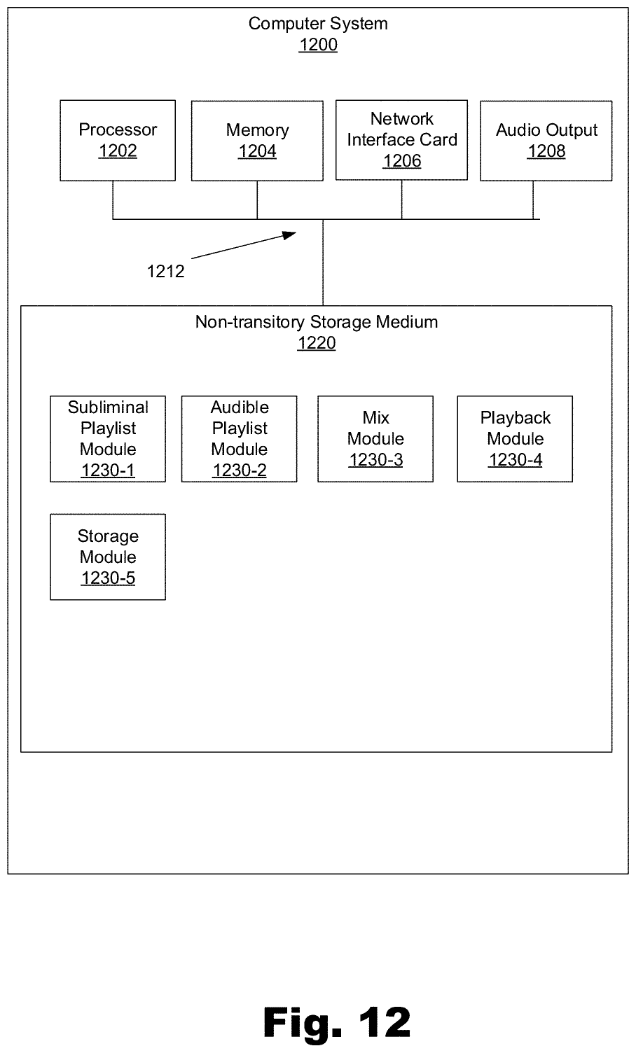

FIG. 12 represents an apparatus for creating subliminal messages according to one example of the principles described herein. FIG. 12 includes a subliminal message creation apparatus (1200). The subliminal message creation apparatus (1200) may include a processor (1202), memory (1204), a network interface card (1206), audio output (1208), a communication bus (1212), and a non-transitory storage medium (1220). The non-transitory storage medium (1220) may include a subliminal playlist module (1230-1), an audible playlist module (1230-2), a mix module (1230-3), a playback module (1230-4), and a storage module (1230-5).

The subliminal playlist module (1230-1) may identify a number of audio messages to be played in an audio range not detectable by human hearing, which may be less than 25 dB, which may be less than 20 dB, which may be between 3 and 5 dB, which may be between 1 and 3 dB. The number of audio messages may be selected from prerecorded audio files or may be created by recording new audio files to create the number of audio messages. The number of audio messages may be motivational instructions, messages, or sayings to provide support, motivation, or reminders to a person listening to an audio output file with a subliminal message track.

The audible playlist module (1230-2) may identify audible audio to be played by the apparatus (1200) for creating subliminal messages. The audible playlist module (1230-2) may identify a number of audible audio files for which a subliminal message track is to be added. The audible playlist module (1230-2) may receive audible audio from an application executing on the apparatus that creates audio output and adds a subliminal message to the audio output of the other application.

The mix module (1230-3) may create an audio output comprising the audible file and the number of audio messages such that the number of audio messages are played in a sub-audible range. The mix module (1230-3) may measure the audible audio to identify a sub-audible range that applies to the audio identified by these audible playlist module (1230-2). The mix module (1230-3) may comprise an audio apparatus control module; the audio apparatus control module may control the audio output (1208) of the subliminal message creation apparatus (1200).

An overall example according to FIG. 12 will now be given. The subliminal playlist module (1230-1) may identify a number of audio files that are stored on the non-transitory storage medium (1220) that may be identified to add to an audio track as a subliminal message. It may include a single audio file, or a plurality of audio files.

The audible playlist module (1230-2) identifies audible audio to which the number of audio files will be added as a subliminal message. In this example the audible playlist module (1230-2) identifies a number of preferred audio files from a user's musical playlist and labels those preferred audio files as audible audio to which the number of audio files will be added as a subliminal message. Preferred audio files may be determined by receiving and storing a user-selection; or an algorithm may be used to select preferred audio files; or a preferred audio module may track the length of time for which a specific audio file is played during a specified time, such as a week or month, and determine preferred audio based on a ranking such as the audio files that have been played a number of times that ranks in the top 20% when compared to the total audio files.

The mix module (1230-3) may create an audio output that comprises the audible audio and the number of audio messages such that the number of audio messages are played in the sub-audible range. The mix module (1230-3) may take control of the audio output (1208) and play the number of audio messages in a sub-audible zone and at the same time play the audible audio on the audio output (1208).

The mix module may set the number of audio messages to be in a sub-audible range by setting the volume of the number of audio messages to be: at or near 0 dB, below 0 dB, less than 20 dB, less than 15 dB, less than 5 dB, between 0.1 dB and 5 dB, less than 1 dB, less than 2 B, or less than 3 dB.

The audio playback module (1230-4) may cause the audio combination of the number of audio messages and the audible audio to be played through the audio output (1208).

The storage module (1230-5) may store the combination of the number of audio messages and the audible audio to a non-transitory storage medium (1220). The storage of the number of audio messages and the audible audio to the non-transitory storage medium may be accomplished by redirecting the output of the audio output (1208).

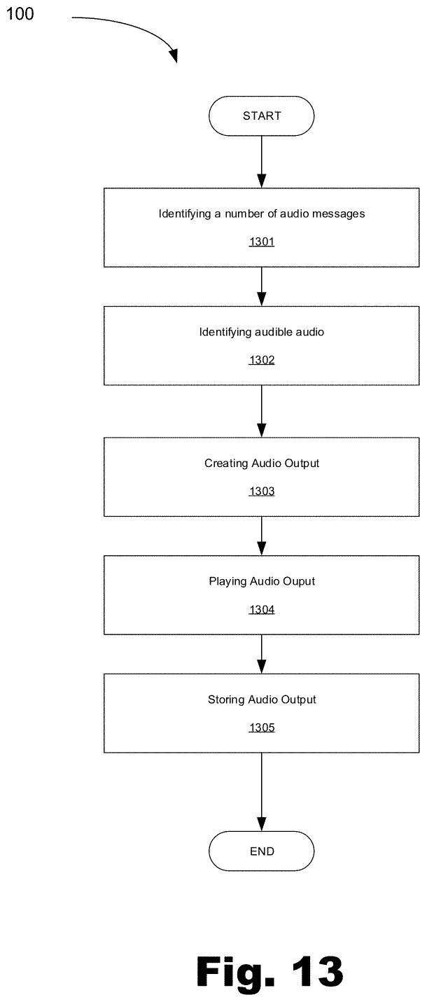

FIG. 13 represents a method for creating subliminal messages, according to one example of the principles described herein. The method may include identifying a number of audio messages (1301), identifying audible audio (1302), creating audio output (1303), playing audio output (1304), and storing audio output (1305).

Identifying a number of audio messages (1301) may include presenting to a user a number of audio files that have been prerecorded as motivational messages or other messages that a user desires to hear in a sub-audible tone. Identifying number of audio messages (1301) may include recording a number of audio files that a user desires to be played in a sub-audible tone with other audible audio files. Motivational messages audio files may be recorded by the user and stored on the apparatus; motivational messages audio files may be received from contacts of the user; a motivational message module may have instructions for sending a message to a contact and requesting that the contact send a motivational message;

Identifying audible audio (1302) identifies audible audio that the number of audio files will be combined with to create audible audio with sub audible messages. Identifying audible audio (1302) may include selecting from a number of audio files audio which the user desires to hear and comprehend well listening to sub audible audio. Identifying audible audio (1302) may include identifying an application that is producing audible audio which the user wishes to combine sub audible audio with.

Creating audio output (1303) comprises combining the audible audio and the number of audio messages such that the number of audio messages are played in a sub audible range well playing the audible audio output using an audio output unit. Creating audio output (1303) may be accomplished by playing the number of audio messages at or near 0 dB. Creating audio output (1303) may be accomplished by playing the number of audio messages at an audio output level in comparison to the audible audio output such that the human ear would not detect audibly the sub audible messages selected from the number of audio messages. Creating audio output (1303) may be accomplished by playing the number of audio messages at an audio frequency such that the human ear does not detect the sub audible output.

Playing audio output (1304) comprises causing the combined audio of the number of audio messages being played in a sub audible range with the audible audio output to be sent to an audio output apparatus.

Storing audio output (1305) comprises storing, on a non-transitory storage medium, the combination of the number of audio messages being played in a sub audible range with the audible audio output such that the audio files stored includes both the number of audio messages played in the sub audible range and the audible audio output.

And over all example according to FIG. 13 will now be given. Identifying a number of audio messages (1301) identifies an audio file of a message from a first party to a second party that the first party has prerecorded.

Identifying audible audio (1302) identifies a number of musical audio files that are preferred by the user of the subliminal message creation apparatus (FIG. 12, 1200). These musical audio files include music popular at the time the subliminal message creation apparatus (1200) is being used.

Creating audio output module (1303) may examine the volume of the audible audio output to identify a sub audible range for the number of audio messages. Creating audio output module (1303) then adjust the audio volume of the number of messages to be played in a sub audible range. Creating audio output module (1303) may continue to monitor the audio output of the apparatus and may adjust the output of the number of messages such that during changes of the audible audio the audio level of the number of messages that are being played in the sub audible range is adjusted to maintain that those number of messages are sub-audible.

Playing audio output (1304) causes the audio output created by creating audio output (1303) to be the communicated to an audio output apparatus associated with the apparatus.

Storing audio output (1305) redirects the play audio output (1304) to create an audio file on a non-transitory storage medium.

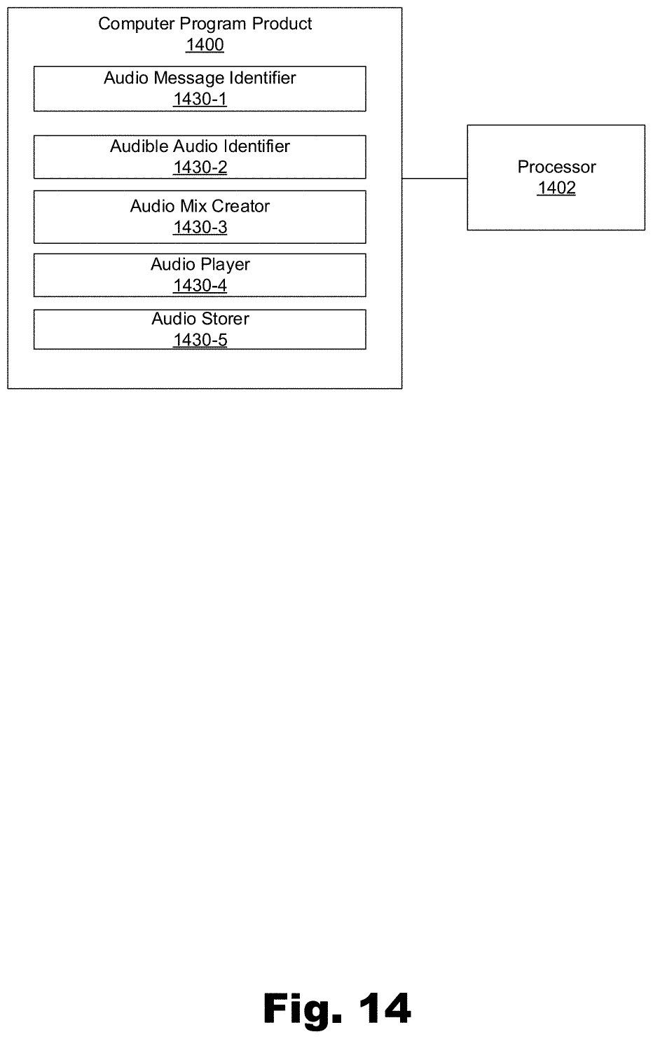

FIG. 14 represents a computer program product (1400) for creating audio output with a sub audible message. The computer program product (1400) includes an audio message identifier (1430-1), an audible audio identifier (1430-2), an audio mix Creator (1430-3), an audio player (1430-4), and an audio storer (1430-5).

The audio message identifier (1430-1) identifies audio messages to be played in an audio range that is not detectable by human hearing.

The audible audio identifier (1430-2) identifies audible audio to be played by an apparatus for creating subliminal messages.

The audio mix Creator (1430-3) creates an audio output that comprises the audible audio and the number of audio messages such that the number of audio messages are played in a sub audible range. The audio mix Creator (1430-3) may create the audio mix by playing the sub audible messages at or near 0 dB. The audio mix Creator (1430-3) may measure the volume of the audible audio and identify a volume for the number of audio messages such that the number of audio messages will not be heard when the audible audio is played. The audio mix Creator (1430-3) may alter the audio frequency of the number of audio messages such that they may be played with the audible audio and not be consciously heard by the human ear.

The audio player (1430-4) plays the audio on an apparatus for creating audio with subliminal messages using an audio output apparatus.

The audio storer (1430-5) may causes the audio output of the apparatus to be stored on a non-transitory storage medium.

And over all example according to FIG. 14 will now be given. The audio message identifier (1430-1) identifies an audio file of information the user desires to hear repeatedly to assist a user in retaining information held in the audio file.

The audible audio identifier (1430-2) identifies an audio file that contains white noise, such as ocean waves, that the user may listen to while sleeping without being disturbed.

The audio mix creator (1430-3) may play the audible audio. The audio mix creator (1430-3) alters the frequency of the number of audio messages such that the human brain does not recognize consciously the number of messages.

The audio player (1430-4) plays the audio mix that is created by the audio mix creator (1430-3).

The audio store (1430-5) stores the audio output on a non-transitory storage medium for later replay.

When the audio mix creator measures the volume of the audible audio and identifies a sub-audio volume level for the number of audio messages, the identification may be done by using an algorithm or by comparing the measured values to recorded values of what is typically a sub-audible audio for humans of different ages; the computer apparatus may have instructions to receive the age of the user.

Referring creating an audio output comprises altering each frequency of the number of audio messages to a corresponding sub-audible frequency, if there is one original frequency, then there may be one corresponding sub-audible frequency. If there are a plurality of audio frequencies, then each audio frequency may be individually converted into a sub-audible frequency.

In some embodiments, creating an audio output comprises altering a plurality of audible frequencies of the number of audio messages to a corresponding plurality of sub-audible frequencies.

Unless explicitly an action performed to “a thing” does not limit to a single occurrence. For example, altering a frequency encompasses altering a plurality of frequencies.

Unless clear otherwise from the context, “unit” is a combination of hardware and/or software that performs a computing task in a computing environment.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description.

1. A computer apparatus for recording and playing back a recording, comprising:
a recording module;
a storage module;
a playback module;
a playlist module;
a mix module;
the playback module engaging in playback of a recording stored in the storage module after recording by the recording module; the mix module enabling simultaneous playback of at least one separate playback module.

2. The computer apparatus of the first claim, the playback module being controlled by an overlay module, such that at least one physical volume buttons of the computer apparatus is controlling a separate playback module or the main audio level of the computer apparatus.

3. The computer apparatus of the second claim, wherein the amplitude of the volume of the playback module is configured to be between 5% and 75%, between 2% and 98%, or between 15% and 60% of the amplitude of the volume of the separate playback module.

4. (canceled)

5. (canceled)

6. An apparatus for creating subliminal messages, the apparatus comprising:
a processing unit;
an audio output unit, the audio output unit communicatively connected to the processing unit;
a subliminal processing unit, the subliminal processing unit comprising a number of modules, the number of modules causing the processing unit to perform a function, the number of modules comprising:
a subliminal playlist module, the subliminal playlist module identifying a number of audio messages to be played in an altered format such that the number of audio messages in the altered format are not detectable by human hearing;
an audible playlist module, the audible playlist module identifying a number of audible audio to be audibly played by the apparatus;
a mix module, the mix module altering the number of audio messages to be played in an altered format, thereby creating a number of altered inaudible audio messages and also creating an audio output comprising the number of audible audio and the number of altered inaudible audio; and,
playback module, the playback module playing the audio output using the audio output unit.

7. The apparatus of claim 6, wherein the mix module further comprises an audio apparatus control module, the audio apparatus control module controlling the audio output unit.

8. The apparatus of claim 6, wherein the audible playlist module receives audio from an application executing on the apparatus for creating subliminal messages.

9. The apparatus of claim 6, wherein the mix module measures audible audio to identify a sub-audible range for the audio.

10. The apparatus of claim 6, further comprising a storage module, the storage module creating an audio file on a non-transitory storage apparatus communicatively connected to the apparatus for creating subliminal messages.

11. A method for creating subliminal messages, the method comprising:
identifying a number of audio messages to be played in an audio range not detectable by human hearing;
identifying audible audio to be played by the apparatus for creating subliminal messages;
creating an audio output comprising the audible audio and the number of audio messages such that the number of audio messages are played in a sub-audible range; and
playing the audio output using the audio output unit.

12. The method of claim 11, wherein creating an audio output comprises playing the number of audio messages at a negative decibel level.

13. The method of claim 11, wherein creating an audio output comprises measuring the volume of the audible audio and identifying a human-inaudible volume for the number of audio messages such that the number of audio messages will not be heard by humans when the audible audio is played.

14. The method of claim 11, further comprising storing the audio output on a non-transitory storage medium.

15. The method of claim 11 wherein creating an audio output comprises altering an audible frequency of the number of audio messages to a corresponding sub-audible frequency.

16. A computer program product, the computer program product comprising a number of modules, the number of modules causing a computing apparatus to perform a particular task, the modules comprising
an audio message identifier, the audio message identifier identifying audio messages to be produced in an audio range not detectable by human hearing;
an audible audio identifier identifying audible audio to be produced by the apparatus for creating subliminal messages;
an audio mix creator creating an audio output comprising the audible audio and the number of audio messages such that the number of audio messages are produced in a sub-audible range; and
an audio player producing the audio output using the audio output unit.

17. The computer program product of claim 16, wherein the audio mix creator creates audio by producing the number of audio messages at a negative decibel level.

18. The computer program product claim 16, wherein the audio mix creator measures the volume of the audible audio, identifies a sub-audio volume level for the number of audio messages.

19. The computer program product of claim 16 further comprising an audio storer storing the audio output on a non-transitory storage medium.

20. The computer program product of claim 16 wherein creating an audio output alters the frequency of the number of audio messages such that they will not be heard by human ears.
